(19) United States
(12) Patent Application Publication
(10) Pub. No.: US 2009/0120412 A1
(43) Pub. Date: May 14, 2009

(54) Plunger Type High-Pressure Fuel Pump

(75) Inventors: Kenichiro Tokuo, Munchen (DE); Satoshi Usui, Hitachinaka (JP); Hiroyuki Yamada, Hitachinaka (JP); Junichi Shimada, Tokyo (JP); Masami Abe, Hitachi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Chiyoda-ku (JP)

(21) Appl. No.: 12/259,999

(22) Filed: Oct. 28, 2008

(30) Foreign Application Priority Data
Oct. 29, 2007 (JP) 2007-280553

(51) Int. Cl. F02M 37/04

(52) U.S. Cl. 123/506; 251/129.15

(57) ABSTRACT

A plunger type high-pressure fuel pump includes a plunger reciprocated in a cylinder. A fluid pressurizing chamber of the pump has a chamber with a capacity that changes with reciprocation of the plunger. An electromagnetic valve is provided between the pressurizing chamber and a fluid suction passage; as well as a discharge valve. The electromagnetic valve includes a valve member including a suction valve; a solenoid coil adapted to displace the valve member; an anchor made of a magnetic material provided integrally with the valve member; and a core forming a magnetic circuit to attract the anchor by the electromagnetic force and dividing the inside of the electromagnetic valve into a hermetically closed space and an external space communicating with the fluid suction passage. The anchor or the core is provided with a fluid passage through which fluid can flow between the hermetically closed space and the external space formed by the anchor and the core, respectively when the suction valve is in an opened state.

### BACKGROUND OF THE INVENTION

1. Field of the Invention

The present invention relates generally to a fuel supply system for an internal combustion engine, and more specifically to an electromagnetic valve structure suitable for stable closing operation of an electromagnetic valve in a plunger type high-pressure fuel pump.

2. Description of the Related Art

Direct injection engines (in-cylinder injection internal combustion engines) for today's automobiles are developed in order to make emissions cleaner and improve fuel consumption in view of environmental protection. The direct injection engines are such that fuel is directly injected by a fuel injection valve into the combustion chamber of a cylinder. In addition, the particle diameter of fuel injected from the fuel injection valve is reduced to promote combustion of the injected fuel, thereby reducing the specific substance in the exhaust gas and improving fuel consumption.

Reducing the particle diameter of fuel injected from the fuel injection valve requires means for high pressurizing fuel. To meet the requirement, various proposals are made of the technology of a high-pressure fuel pump which supplies high-pressure fuel under pressure to the fuel injection valve (see e.g. JP-A-2006-256086). The technology described in JP-A-2006-256086 relates to a high-pressure fuel pump provided with a normally-closed electromagnetic valve as a suction valve. During a suction stroke, fluidic force is used to naturally open the suction valve, thereby achieving reduction of hitting sound of the valve member which may be caused at the time of valve-opening operation.

An air gap between the attractive member and movable member of an electromagnetic drive section in a hydraulic control valve is minimized by electromagnetic force resulting from energization. This makes it easy to cause negative pressure, which disadvantageously leads to the occurrence of a cavity. To prevent this, reform measures are disclosed in which the attractive member or movable member is provided, in an end face, with an opening portion formed as a fuel groove (see e.g. JP-A-2004-137996).

For example, JP-A-2005-511952 discloses a flow rate control device that controls a flow rate of liquid flowing through a valve operatively opened and closed by electromagnetic force. This device is configured such that a movable element moved by the electromagnetic force is provided with a swirling flow path to thereby prevent uneven wear of a sliding portion and to speed up valve opening and closing operation.

### SUMMARY OF THE INVENTION

The high-pressure fuel pump described in JP-A-2006-250086 repeats the intermittent suction and discharge of fuel; therefore, pressure pulsation is generated in piping upstream of and downstream of the fuel pump. For example, pressure on the low pressure piping side lowers when fuel is sucked by the high pressure fuel pump and rises when discharged. If such pressure variations occur, the opening and closing timing of the electromagnetic valve becomes unstable. Thus, fuel to be discharged cannot accurately be controlled.

JP-A-2004-137996 and 2005-511952 disclose the provision of the fuel passage in the movable member or attractive member of the electromagnetic valve. However, this structure is devised to prevent the occurrence of the cavity resulting from the negative pressure caused in the air gap portion. In addition, the structure is devised to speed up the operation of the movable element in the electromagnetic valve. In other words, consideration is not made in view of stabilizing the closing timing of the electromagnetic valve irrespective of the internal and external pressure variations of the electromagnetic valve.

It is an object of the present invention to provide a plunger type high-pressure fuel pump that can stabilize the closing timing of an electromagnetic valve so as to discharge fuel at a stable flow rate for each cycle while valve-closing operation is not varied under a pressure difference between a hermetically closed space in the electromagnetic valve of the plunger type high-pressure fuel pump and an external space formed outside of the hermetically closed space.

In accordance with an aspect of the present invention, a plunger type high-pressure fuel pump includes: a cylinder provided in the pump; a plunger provided slidably in the cylinder and reciprocated according to rotation of a cam; a fluid pressurizing chamber wjocj defined between the plunger and the cylinder and has a volume that changes with reciprocation of the plunger; an electromagnetic valve provided in a space defined between the pressurizing chamber and a fluid suction passage; and a discharge valve provided in a space defined between the pressurizing chamber and a fluid discharge passage. The electromagnetic valve includes: a valve member including a suction valve opening and closing an inlet side of the pressurizing chamber; an elastic member for biasing the valve member in a valve-opening direction; a solenoid coil adapted to displace the valve member in an opening direction; an anchor made of a magnetic material operated by electromagnetic force of the solenoid coil and provided integrally with the valve member; and a core forming a magnetic circuit to attract the anchor in an opening direction by the electromagnetic force and dividing the inside of the electromagnetic valve into a hermetically closed space and an external space communicating with the fluid suction passage. The anchor or the core is provided with a fluid passage through which fluid can flow between the hermetically closed space and the external space formed by the anchor and the core, respectively when the suction valve is in an opened state.

According to the aspect of the present invention, the anchor or the core is provided with the fluid passage through which fluid can flow between the hermetically closed space of the electromagnetic valve and the external space at the time of opening the valve. This can stabilize the closing timing of the electromagnetic valve. Thus, the plunger type high-pressure fuel pump can discharge fuel at a stable flow rate for each cycle.

### BRIEF DESCRIPTION OF THE DRAWINGS

FIG. 1 illustrates the entire structure of a fuel supply system using a plunger type high-pressure fuel pump according to an embodiment of the present invention.

FIG. 2 is a cross-sectional view illustrates the structure of the high-pressure fuel pump according to the embodiment.

FIG. 3 is a diagram for assistance in explaining pressure situations in an electromagnetic valve and around a pressurizing chamber in the plunger type high-pressure fuel pump according to the embodiment.

FIG. 4 is a cross-sectional view illustrating a detailed structure of the electromagnetic valve in the plunger type high-pressure fuel pump according to the embodiment.

FIG. 5 is a cross-sectional view illustrating a configurational example in which a passage hole is provided in an anchor (which is configured integrally with a valve member of the electromagnetic valve and is magnetically attracted by a core) to communicate between a hermetically closed space formed inside the electromagnetic valve and an external space formed outside of the hermetically closed space, in the plunger type high-pressure fuel pump according to the present embodiment.

FIG. 6 is a cross-sectional view illustrating a configurational example in which the passage hole is provided in the core (which forms a magnetic circuit-forming body along with the valve member of the electromagnetic valve) to communicate between the hermetically closed space formed inside the electromagnetic valve and the external space formed outside of the hermetically closed space, in the plunger type high-pressure fuel pump according to the present embodiment.

FIG. 7 illustrates another configurational example in which the passage hole is provided in the core (which forms the magnetic circuit-forming body along with the valve member of the electromagnetic valve) to communicate between the hermetically closed space formed inside the electromagnetic valve and the external space formed outside of the hermetically closed space, in the plunger type high-pressure fuel pump according to the present embodiment.

FIG. 8 illustrates other configurational examples in which the passage hole is provided in each of the core and the anchor to communicate between the hermetically closed space formed inside the electromagnetic valve and the external space formed outside of the hermetically closed space, in the plunger type high-pressure fuel pump according to the present embodiment.

### DESCRIPTION OF THE PREFERRED EMBODIMENTS

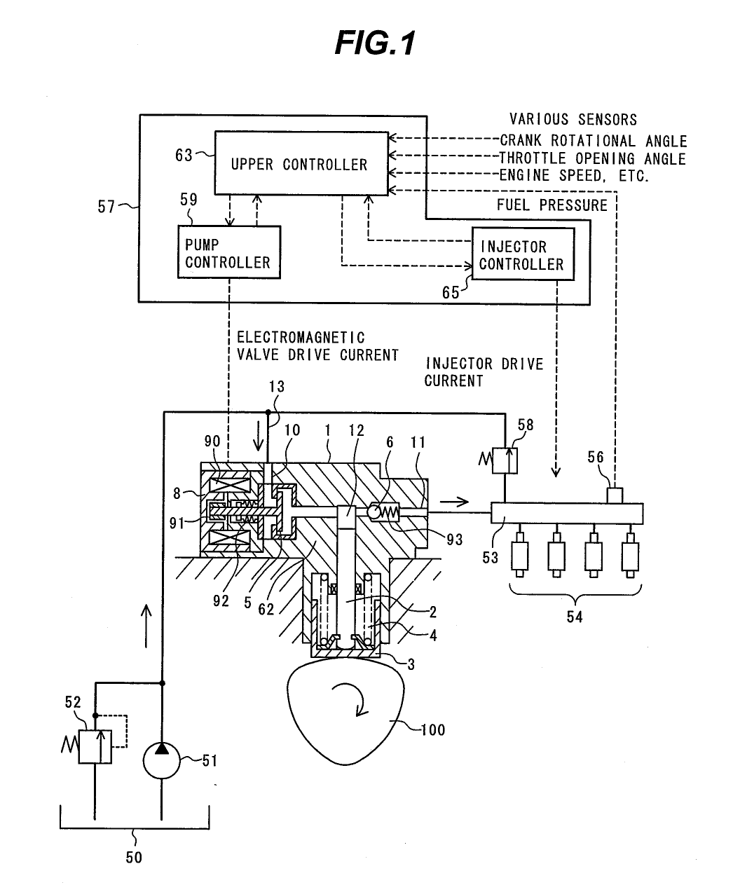

A plunger type high-pressure fuel pump according to embodiments of the present invention will hereinafter be described in detail with reference to FIGS. 1 through 8.

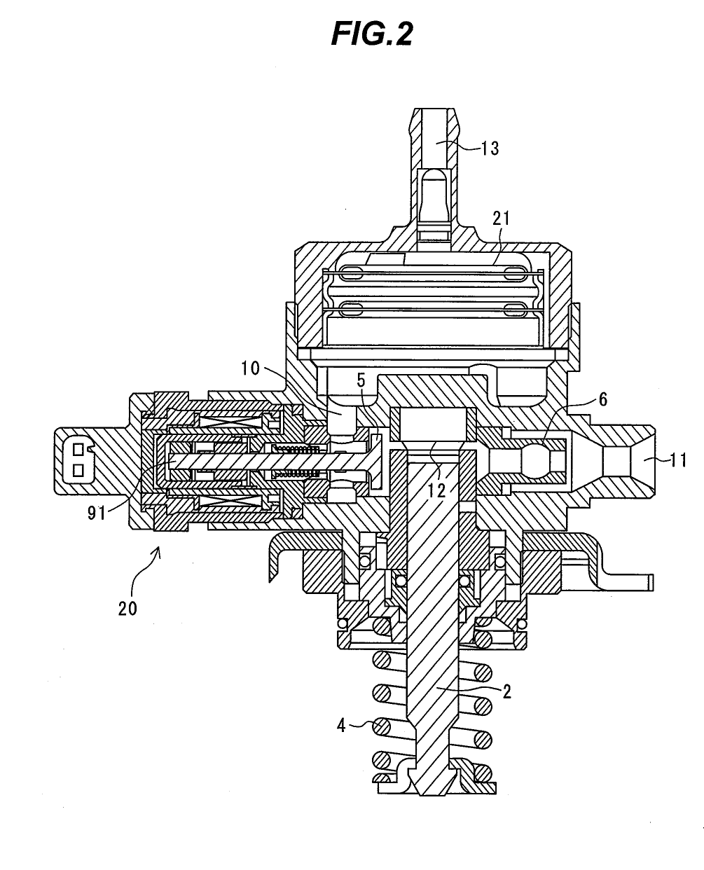

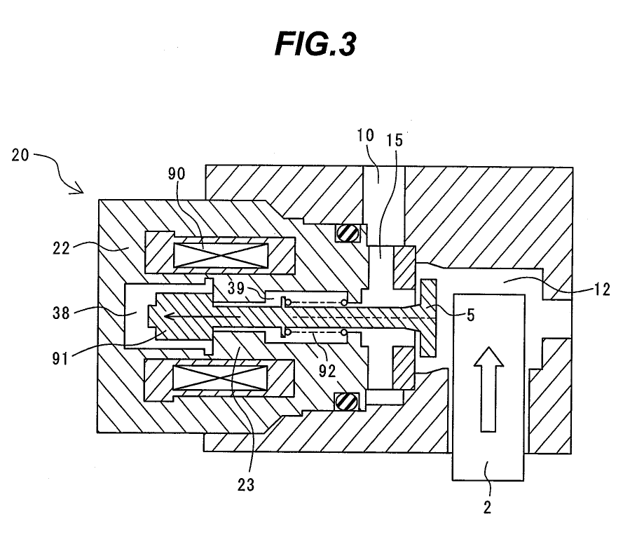

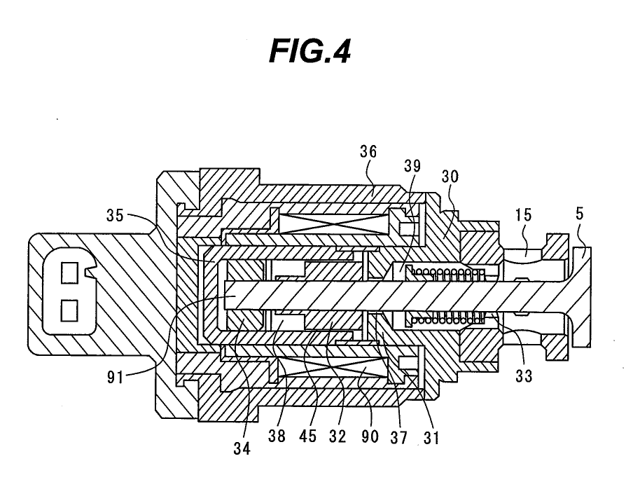

FIG. 1 illustrates the entire structure of a fuel supply system using the plunger type high-pressure fuel pump according to an embodiment of the present invention. FIG. 2 is a cross-sectional view illustrates the structure of the plunger type high-pressure fuel pump according to the embodiment. FIG. 3 is a diagram for assistance in explaining pressure situations in an electromagnetic valve and around a pressurizing chamber in the plunger type high-pressure fuel pump according to the embodiment. FIG. 4 is a cross-sectional view illustrating a detailed structure of an electromagnetic valve in the plunger type high-pressure fuel pump relating to the embodiment.

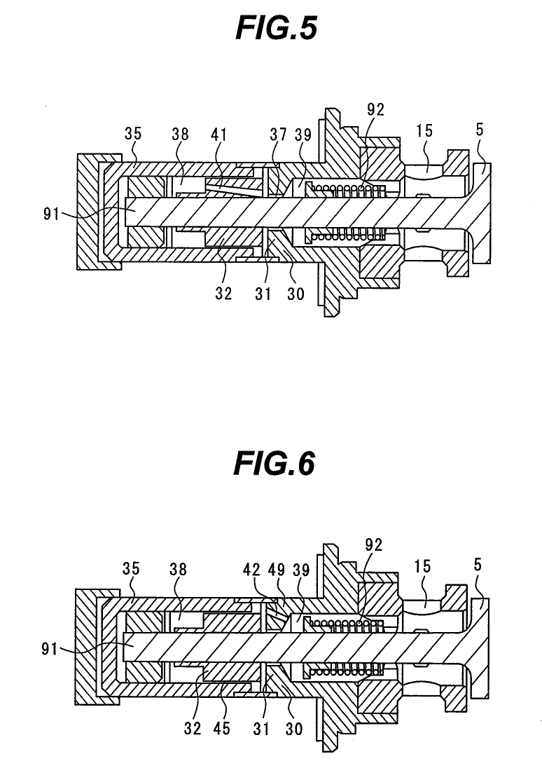

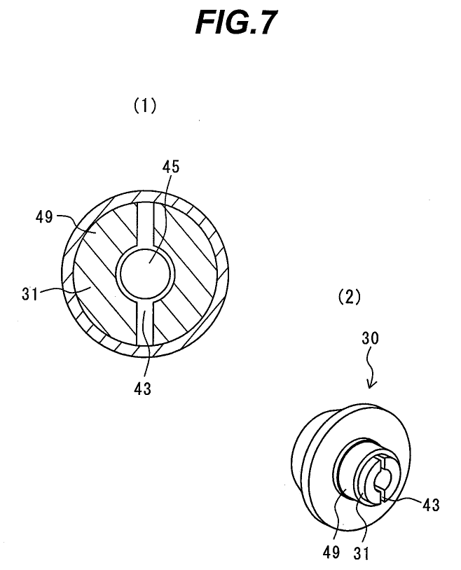

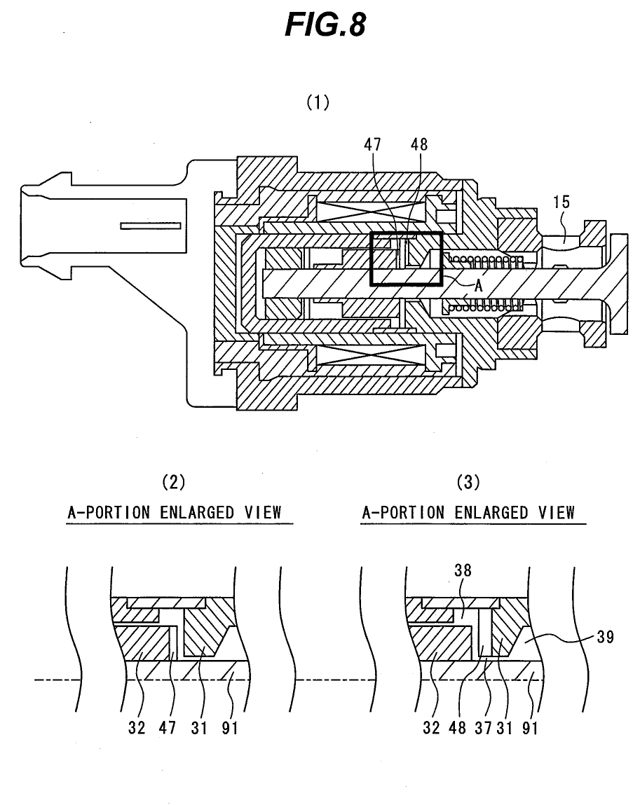

FIG. 5 is a cross-sectional view illustrating a configurational example in which a passage hole is provided in an anchor (which is configured integrally with a valve member of the electromagnetic valve and is magnetically attracted by a core) to communicate between a hermetically closed space formed inside the electromagnetic valve and an external space formed outside of the hermetically closed space, in the plunger type high-pressure fuel pump according to the present embodiment. FIG. 6 is a cross-sectional view illustrating a configurational example in which the passage hole is provided in the core (which forms a magnetic circuit-forming body along with the valve member of the electromagnetic valve) to communicate between the hermetically closed space formed inside the electromagnetic valve and the external space formed outside of the hermetically closed space, in the plunger type high-pressure fuel pump according to the present embodiment. FIG. 7 illustrates another configurational example in which the passage hole is provided in the core (which forms the magnetic circuit-forming body along with the valve member of the electromagnetic valve) to communicate between the hermetically closed space formed inside the electromagnetic valve and the external space formed outside of the hermetically closed space, in the plunger type high-pressure fuel pump according to the present embodiment. FIG. 8 illustrates other configurational examples in which the passage hole is provided in each of the core and the anchor to communicate between the hermetically closed space formed inside the electromagnetic valve and the external space formed outside of the hermetically closed space, in the plunger type high-pressure fuel pump according to the present embodiment.

With reference to FIG. 1, a description is first given of the entire structure of the fuel supply system using the plunger type high-pressure fuel pump 1 according to the embodiment. The high-pressure fuel pump 1 is formed with a fuel suction passage 10, a fuel discharge passage 11, and a pressurizing chamber 12. A plunger 2, a pressurizing member, is slidably held by a cylinder portion 62 inside the high-pressure fuel pump 1.

An end portion of the plunger 2 forms part of the pressurizing chamber 12. The plunger 2 is reciprocated by the rotation of a cam 100 to vary the volume of the pressurizing chamber 12. A suction valve 5 and a discharge valve 6 are installed in the fuel suction passage 10 and the fuel discharge passage 11, respectively. The suction valve 5 and the discharge valve 6 are held in one direction by springs 92 and 93, respectively, and each serve as a check valve for limiting the flow direction of fuel.

An electromagnetic actuator 8 is held in the high-pressure fuel pump 1 and includes a solenoid coil 90, a rod (a valve member) 91, and the spring 92. The rod 91 receives a biasing force applied thereto by the spring 92 in the closing direction of the suction valve 5 with a drive signal not given to the electromagnetic actuator 8. Thus, the suction valve 5 is brought into a closed state as shown in FIG. 1.

Fuel is led by a low-pressure pump 51 from a tank 50 to a fuel introduction port 13 (see FIG. 2) of the high-pressure fuel pump 1 while the pressure of the fuel is regulated to a given pressure by a pressure regulator 52. Thereafter, the fuel is pressurized by the high-pressure fuel pump 1 and supplied under pressure from the fuel discharge passage 11 to a common rail 53. Injectors 54, a pressure sensor 56, and a safety valve 58 are attached to the common rail 53.

When the fuel pressure in the common rail 53 exceeds a predetermined value, the safety valve 58 opens to prevent damage to a high-pressure piping system. The injectors 54 attached have the number made equal to that of cylinders of an engine and inject fuel in response to signals of a controller 57. The controller 57 includes an upper controller 63, a pump controller 59, and an injector controller 65.

The pressure sensor 56 sends pressure data obtained to the upper controller 63. The upper controller 63 calculates an appropriate amount of injection fuel and fuel pressure, etc. on the basis of engine state amounts (a crank rotational angle, a throttle opening angle, engine speed, fuel pressure, etc.) obtained from various types of sensors.

In addition, the upper controller 63 calculates timing to drive the high-pressure fuel pump 1 and the injectors 54 and a flow rate and sends drive signals thereto. In the figure, the controller 57 is separately configured to include the upper controller 63 for calculating a command value; the pump controller 59 for directly sending a drive signal to the high-pressure fuel pump 1; and the injector controller 65 for sending drive signals to the injectors 54. However, the controller 57 may be configured to bring them into one unit.

The plunger 2 is reciprocated by the cam 100 rotated by the engine camshaft or the like to increase and reduce the volume of the pressurizing chamber 12. If the plunger 2 is moved upward in FIG. 1, the volume of the pressurizing chamber 12 is reduced. On the other hand, the plunger 2 is moved downward, the volume of the pressurizing chamber 12 is increased.

During the discharge stroke of the plunger 2, if the electromagnetic actuator 8 is operated (by de-energizing the solenoid coil 90) to close the suction valve 5, the pressure in the pressurizing chamber 12 is increased to automatically open the discharge valve 6. Thus, fuel is supplied under pressure to the common rail 53. The suction valve 5 is automatically closed by the spring 92 even if the pressure of the pressurizing chamber 12 is lower than that of the fuel suction passage 10. However, the opening of the suction valve 5 is determined by the on-operation of the electromagnetic actuator 8.

The plunger type high-pressure fuel pump according to the present embodiment is such that the closing timing of the electromagnetic valve thereof is controlled by the pump controller 59 to thereby control the volume of fuel discharged through the discharge valve. If the electromagnetic actuator 8 is given a drive signal by the pump controller 59, the solenoid coil 90 is energized to generate an electromagnetic field to thereby move the rod 91 rightward, in the example of the figure, against the biasing force of the spring 92. Then, if the plunger 2 is moved downward during the intake stroke, fuel is sucked from the suction passage 10 into the pressurizing chamber 12. Next, if the plunger 2 is moved upward from the bottom dead center to open the suction valve 5, since the suction valve 5 is opened, the fuel in the pressurizing chamber 12 is returned to the suction passage 10 along with the upward movement of the plunger 2. In this case, the discharge valve 6 is set not to be opened by the pressure in the pressurizing chamber 12 (the so-called spill stroke is formed). In such a case, the discharge flow rate of the high-pressure fuel pump is zero.

Subsequently, in the middle of the upward movement of the plunger 2 (in the middle of the spill stroke), if the drive signal sent to the electromagnetic actuator 8 is interrupted (if a drive current is cut off), the rod 91 is shifted by the biasing force of the spring 92 to bring the suction valve 5 into a closed state. The further upward movement of the plunger 2 increases the pressure in the pressurizing chamber 12 to a level higher than a predetermined value to press and open the discharge valve 6. This brings the spill stroke in the discharge stroke, in which fuel is supplied under pressure to the common rail 53. In this way, timing to turn off the drive signal sent to the electromagnetic actuator 8 is adjusted to variably adjust the discharge flow rate in a range from zero to the maximum discharge rate. In addition, the upper controller 63 calculates appropriate discharge timing on the basis of a signal of the pressure sensor 56. The pump controller 59 turns on and off the drive signal sent to the electromagnetic actuator 8. Thus, the pressure of the common rail 53 can be maintained at a general steady value.

FIG. 2 depicts the structure of the plunger type high-pressure fuel pump according to the present embodiment. In this pump structure, fuel is led from the fuel introduction port 13 via the fuel suction passage 10 to the pressurizing chamber 12 in which the fuel is increased in pressure and thus the pressurized fuel is supplied to the fuel discharge passage 11. In FIG. 2, shown are the plunger 2, the plunger-biasing spring 4, the suction valve 5, the discharge valve 6, the electromagnetic valve 20, the rod (valve member) 91 of the suction valve 5, and an accumulator 21 (used to absorb low-pressure side pressure pulsations).

FIG. 3 is a diagram for assistance in explaining pressure situations in the electromagnetic valve 20 and around the pressurizing chamber 12 in the plunger type high-pressure fuel pump. FIG. 3 illustrates the spill stroke described above, situations where the plunger 2 is moved upward to be increasing the fuel pressure in the pressurizing chamber 12 and a state where the solenoid coil 90 is just about to be de-energized to close the suction valve 5. Since the solenoid coil 90 is turned on in this situation, a right end of a left end side large-diameter portion of the rod (the valve member) 91 is abutted at a left end against a projecting portion 23 of the electromagnetic valve member so that a hermetically closed space 38 surrounded by such components is defined. Incidentally, when the solenoid coil 90 is energized, the rod 91 is moved rightward so that the large-diameter portion right end is abutted against the projecting portion 23 of the electromagnetic valve member 22. Thus, the rod 91 is positioned and stopped. In this stopped state, the hermetically closed space 38 is defined inside the electromagnetic valve.

Consideration is now made to the pressure relationship between the hermetically closed space described above and an external space (in which the spring 92 of the electromagnetic valve 20, the periphery of the suction valve 5, the pressurizing chamber 12, the in-valve passage 15, and the suction passage 10 are present) adjacent to the hermetically closed space. The pressure in the hermetically closed space defined inside the electromagnetic valve encountered when the electromagnetic valve is opened is equal to in the external space encountered when the electromagnetic valve is just opened. However, the pressure in the external space is pulsated and momentarily varied due to the pressure variations of a fuel source and to the operation of the plunger. This causes a pressure difference between the internal space and the external space. This pressure difference causes variations in the closing operation of the electromagnetic valve even if timing to turn off the drive current supplied to the solenoid coil is the same. For example, if the inside pressure of the hermetically closed space is low and the outside pressure of the external space is high, then the valve-closing timing will be accelerated. Specifically, the occurrence of the variations between the inside pressure and the outside pressure varies the valve-closing operation (the valve member operation varies even if the command of the valve-closing timing is issued at the same time). Consequently, the variations of the valve-closing operation affect the accurate control of the discharge amount of fuel.

The object of the invention is to reduce the variations of the closing operation of the electromagnetic valve used in the plunger type high-pressure fuel pump. To that end, the major characteristic, i.e., the outline, of the present embodiment is that a fuel passage is provided to communicate between the hermetically closed space defined inside the electromagnetic valve and the external space formed outside of the hermetically closed space while the electromagnetic valve is opened, thereby preventing the occurrence of the internal-external pressure difference.

FIG. 4 is a cross-sectional view illustrating the detailed structure of an electromagnetic valve in a plunger type high-pressure fuel pump relating to the embodiment of the present invention. In addition, FIG. 4 illustrates a basic configuration to which the characteristic structure of the embodiment is applied. In FIG. 4, shown are the suction valve 5, the fuel suction passage 10, the in-valve passage 15 (a fluid passage in the electromagnetic valve communicating with the suction passage 10 present in the high-pressure fuel pump 1), the solenoid coil 90, the rod (the valve member) 91, a core 30 (the electromagnetic valve member forming a magnetic circuit), a core projecting portion 31 (an electromagnetic valve member projecting portion), an anchor 32 (a magnetic body press fitted into the valve member 91 and magnetically attracted by the core 30), valve member guides 33, 34, a magnetic circuit-forming body 35, a frame 36 forming a magnetic path, a clearance 37, the hermetically closed space 38, and the external space 39.

In FIG. 4, to open the suction valve 5, the solenoid coil 90 is energized to allow the core 30, the frame 36, the magnetic circuit-forming body 35, and the anchor 32 to form the magnetic circuit. Thus, the anchor 32 is magnetically pulled by the core projecting portion 31 of the core 30 against the biasing force of the spring 92 to define the hermetically closed space 38 inside the electromagnetic valve. Specifically, in the figure, the right end side of the anchor 32 is brought into close contact with the left end side of the core projecting portion 31 to define the hermetically closed space 38. A clearance 37 is defined between the core projecting portion 31 and the rod (the valve member) 91 so as to enable smooth left-right movement of the rod 91. Likewise, a clearance 45 is defined between the outer circumferential surface of the anchor 32 and the inner circumferential surface of the magnetic circuit-forming body 35.

FIGS. 5 through 8 illustrate the characteristics of the embodiments of the invention as configurational examples in which a fuel passage communicates between the inside and outside of the electromagnetic valve while the electromagnetic valve is opened. The provision of this communicating fuel passage can stabilize the closing timing of the electromagnetic valve. The configurational examples of FIGS. 5 and 6 prevent the performance (attractive force) of the electromagnetic valve from lowering by providing the communicating fuel passage at a portion other than a magnetic attractive surface.

In FIG. 5, the anchor 32 is internally and inclinedly formed with a passage hole 41 as a passage allowing the inside of the electromagnetic valve to communicate with the outside thereof while the electromagnetic valve is opened, that is, as a communicating passage between the hermetically closed space 38 and the external space 39. The passage hole 41 is inclined because the right end of the passage hole 41 is disposed to face the clearance 37 between the core projecting portion 31 and the valve member 91. Thus, the passage hole 41 communicates with the external space 39.

In this way, the fuel in the hermetically closed space 38 communicates with the fuel in the external space 39 via the clearance 37. The fuel passage in the configurational example of FIG. 5 is formed as the inclined passage hole 41. However, the fuel passage is not limited to this. The fuel passage may be a passage hole having any shape as long as the right end of the anchor 32 is disposed to face the clearance 37. For example, an L-shaped passage hole may be applicable in which a hole is formed to extend from a position facing the clearance 45 between the magnetic circuit forming body 45 and the anchor 32 toward the valve member 91 and further extends along the inner circumferential side of the anchor 32.

In FIG. 6, a passage hole 42 is inclinedly formed inside the core projecting portion 31 (a structure adapted to attract the right end of the anchor 32) of the core 30 (which forms the body or member of the electromagnetic valve and which is a magnetic path forming body), as a passage communicating between the hermetically closed space 38 and the external space 39 while the electromagnetic valve is opened. Thus, the hermetically closed space 38 is allowed to communicate with the external space 39 through the passage hole 42. In the example of FIG. 6, the left end of the passage hole 42 is disposed to be offset from a position opposed to the right end portion of the anchor 32 (the passage hole 42 is disposed at a position other than a magnetic attractive surface). This prevents the core 30 from lowering the force of attracting the anchor 32.

With reference to FIGS. 7 and 8, a description is next given of a configurational example in which a passage communicating between the hermetically closed space 38 and the external space 39 at the time of opening the electromagnetic valve is provided in a magnetic attractive surface. FIG. 7 depicts a passage-groove 43 provided at a portion of the magnetic attractive surface of the core projecting portion 31 included in the core 30. In FIG. 7, reference numeral 30 denotes a whole structure of the core, 31 denotes the core projecting portion of the core 30, 46 denotes a valve member insertion hole, and 49 denotes a core upper-lower lateral surface (see FIG. 6).

The passage-groove 43 shown in FIG. 7 is the same as a passage groove 48 shown in FIG. 8(3). The hermetically closed space 38 is allowed to communicate with the external space 39 through the passage-groove 43 formed at a portion of the magnetic attractive surface of the core. As shown in FIG. 7, although the passage-groove 43 causes the magnetic attractive force to slightly lower, the magnetic attractive surface needs only groove machining. Thus, fabrication can be facilitated.

FIG. 8(2) illustrates a passage-groove 47 provided at a portion of the magnetic attractive surface of the anchor 32 by way of example. The function and operation of this configurational example are the same as those of FIG. 8(3). FIG. 8(1) illustrates a configurational example in which the core 30 and the anchor 32 are provided with passage-grooves 48 and 47, respectively. This makes the magnetic attractive force equal to that of the case where the passage-grooves are individually provided and aims to facilitate the fuel communication between the hermetically closed space 38 and the external space 39. In other words, this can eliminate a disadvantage that if fuel is hard to flow between the hermetically closed space and the external space, the valve member operates slowly.

In the examples of FIGS. 7 and 8, since the core or the anchor is formed with the passage-groove on the magnetic attractive surface, the magnetic attractive force slightly lowers. To prevent such lowering, the magnetic attractive surfaces (the opposite surfaces) of the core and of the anchor are each subjected to plating and the passage-grooves are formed on the plated portions as shown in FIGS. 7 and 8. With this structure, since the magnetic attractive surfaces of the core and of the anchor are not ground, it is possible to prevent the lowering of the magnetic attractive force.

1. A plunger type high-pressure fuel pump comprising:
a cylinder provided in the pump;
a plunger provided slidably in the cylinder and reciprocated according to rotation of a cam;
a fluid pressurizing chamber provided in the pump, said pressurizing chamber having a capacity that changes with reciprocation of the plunger;
an electromagnetic valve provided in a space defined between the pressurizing chamber and a fluid suction passage; and
a discharge valve provided in a space defined between the pressurizing chamber and a fluid discharge passage;
wherein the electromagnetic valve includes:
a valve member including a suction valve opening and closing an inlet side of the pressurizing chamber;
an elastic member for biasing the valve member in a valve-opening direction;
a solenoid coil adapted to displace the valve member in an opening direction;
an anchor made of a magnetic material operated by electromagnetic force of the solenoid coil provided integrally with the valve member; and
a core forming a magnetic circuit to attract the anchor in an opening direction by the electromagnetic force and dividing the inside of the electromagnetic valve into a hermetically closed space and an external space communicating with the fluid suction passage; and
wherein the anchor or the core is provided with a fluid passage through which fluid can flow between the hermetically closed space and the external space formed by the anchor and the core, respectively when the suction valve is in an opened state.

2. The plunger type high-pressure fuel pump according to claim 1, wherein the core is provided at a central portion with an insertion port adapted to receive the valve member inserted therethrough and on the outside of the insertion port with an abutment surface in abutment against the anchor, and the abutment surface is formed with a radially fluid passage-groove.

3. The plunger type high-pressure fuel pump according to claim 1, wherein the anchor has an abutment surface in abutment against the fixed core, the abutment surface being formed with a radially fluid passage-groove, and fluid in the hermetically closed space communicates with the external space via the fluid passage-groove of the anchor and via a clearance between the core and the valve member.

4. The plunger type high-pressure fuel pump according to claim 1, wherein the core is provided at a central portion with an insertion port adapted to receive the valve member inserted therethrough and on the outside of the insertion port with an abutment surface in abutment against the anchor, as well as on the outside of the abutment surface with a non-abutment surface in non-abutment against the anchor, and
the core is internally formed with a fluid passage hole between the non-abutment surface and a surface in contact with the external space.

5. The plunger type high-pressure fuel pump according to claim 1, wherein the anchor has an abutment surface opposed to and abutted against the core inserting through the valve member, and the anchor is internally formed with a fluid passage hole between the abutment surface of the anchor opposed to a clearance between the core and the valve member and a surface of the anchor in contact with the hermetically closed space.

6. The plunger type high-pressure fuel pump according to claim 1, wherein:
the core is provided at a central portion with an insertion port adapted to receive the valve member inserted therethrough and on the outside of the insertion port with an abutment surface in abutment against the anchor, and the abutment surface being provided with a plating surface subjected to plating,
the anchor has an abutment surface in abutment against the fixed core, the abutment surface being provided with a plating surface subjected to plating, and
the plated surface of the core and/or the plated surface of the anchor is provided with a radially fluid passage groove.
